(19) United States
(12) Patent Application Publication
(10) Pub. No.: US 2005/0286527 A1
(43) Pub. Date: Dec. 29, 2005

(54) TCP segment re-ordering in a high-speed TOE device

(75) Inventors: Francis Tieu, Duluth, GA (US); Mark Lin, Atlanta, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: iVivity, Inc., Norcross, GA (US)

(21) Appl. No.: 10/962,840

(22) Filed: Oct. 12, 2004

Related U.S. Application Data
(60) Provisional application No. 60/583,310, filed on Jun. 28, 2004.

(51) Int. Cl. H04L 12/28

(52) U.S. Cl. 370/394; 370/401

(57) ABSTRACT

A method and single chip device having limited on-chip memory for processing and reordering out-of-order TCP segments in a high-speed TCP communication system, wherein in-order TCP segments are forwarded on to an appropriate application, includes storing a first out-of-order TCP segment in the limited on-chip memory, the first out-of-order TCP segment defining a SACK region, determining the gap between a last-received in-order TCP segment and the SACK region, for each later-received out-of-order TCP segment that is contiguous with but non-cumulative with the SACK region, storing said later-received out-of-order TCP segment in the limited on-chip memory of the high-speed TCP receiving device; and expanding the SACK region to include said later-received out-of-order TCP segment, and when the gap between the last received in-order TCP segment and the SACK region is filled, forwarding each out-of-order TCP segment included within the SACK region on to the appropriate application.

### CROSS REFERENCE TO RELATED APPLICATION

This application claims the benefit under 35 U.S.C. § 119(e) of U.S. provisional patent application No. 60/583,310, entitled “TOE METHODS AND SYSTEMS,” filed Jun. 28, 2004, which is incorporated herein in its entirety by reference.

### FIELD OF THE PRESENT INVENTION

The present invention relates generally to computer communication systems and protocols, and, more particularly, to methods and systems for tracking and re-ordering TCP segments in a high speed, limited memory TCP dedicated hardware device.

### BACKGROUND OF THE PRESENT INVENTION

TCP/IP is a protocol system—a collection of protocols, rules, and requirements that enable computer network communications. At its core, TCP/IP provides one of several universally-accepted structures for enabling information or data to be transferred and understood (e.g., packaged and unpackaged) between different computers that communicate over a network, such as a local area network (LAN), a wide area network (WAN), or a public-wide network, such as the Internet.

The “IP” part of the TCP/IP protocol stands for “Internet protocol” and is used to ensure that information or data is addressed, delivered, and routed to the appropriate entity, network, or computer system. In contrast, “TCP,” which stands for “transport control protocol,” ensures that the actual content of the information or data that is transmitted is received completely and accurately. To ensure such reliability, TCP uses extensive error control and flow control techniques. The reliability provided by TCP, however, comes at a cost—increased network traffic and slower delivery speeds—especially when contrasted with less reliable but faster protocols, such as UDP (“user datagram protocol”).

A typical network 100 is illustrated in FIG. 1 and includes at least two remote machines in communication with each other over a communications medium. Specifically, as shown, one machine 110 is a sending computer, server, or system (which we will arbitrarily designate as the “source machine”) that communicates over a communications medium or network, such as the Internet 150, with another machine 160, which is the receiving computer, server, or system (which we will arbitrarily designate as the “destination machine”). Data or information typically travels in both directions 120, 130 between the source machine 110 and the destination machine 160 as part of a normal electronic communication.

It is helpful to understand that the TCP/IP protocol defines discrete functions that are to be performed by compliant systems at different “layers” of the TCP/IP model. As shown in FIG. 2, the TCP/IP model 200 includes four layers, namely, the network access layer 210, the internet layer 220, the transport layer 230, and the application layer 240. Each layer is intended to be independent of the other layers, with each layer being responsible for different aspects of the communication process. For example, the network access layer 210 provides a physical interface with the physical network and formats data for the transmission medium, addresses data based on physical hardware addresses, and provides error control for data delivered on the physical network. Among other things, the internet layer 220 provides logical, hardware-independent addressing to enable data to pass between systems with different architectures. The transport layer 230 provides flow control, error control, and acknowledgment services, and serves as an interface for network applications. The application layer 240 provides computer applications for network troubleshooting, file transfer, remote control, and Internet activities.

According to TCP/IP protocol, each layer plays its own role in the communications process. For example, out-going data from the source machine is packaged first at the application layer 240, and then it is passed down the stack for additional packaging at the transport layer 230, the internet layer 220, and then finally the network access layer 210 of the source machine before it is transmitted to the destination machine. Each layer adds its own header (and/or trailer) information to the data package received from the previous higher layer that will be readable and understood by the corresponding layer of the destination machine. Thus, in-coming data received by a destination machine is unpackaged in the reverse direction (from network access layer 210 to application layer 240), with each corresponding header (and/or trailer) being read and removed from the data package by the respective layer prior to being passed up to the next layer.

The process 300 of encapsulating data at each successive layer is illustrated briefly in FIG. 3. For example, out-going user data 305 is packaged by a computer application 341 to include application header 345. The data package 340 created by the application 341 is called a “message.” The message 340 (also shown as application data 342) is further encapsulated by a TCP manager 331 to include TCP header 335 (note: for purposes of the present invention and discussion, the transport layer is TCP rather than another protocol, such as UDP). The data package 330 created by the TCP manager 331 is called a “segment” The segment 330 is encapsulated further by the IP manager 321 to include IP header 325. The data package 320 created by the IP manager 321 is called a “datagram.” The datagram 320 is encapsulated yet further by an Ethernet driver 311 (at the network access layer) to include Ethernet header 315 and Ethernet trailer 316. The data package 310 created by the Ethernet driver 311 is called a “frame.” This frame 310 is a bitstream of information that is transmitted, as shown in FIG. 1, across the communications medium 150 from the source machine 110 to the destination machine 160. As stated previously, the process at the destination machine 160 of unpacking each data package occurs by layer, in the reverse order.

It should be understood that the amount of data that needs to be transmitted between machines often exceeds the amount of space that is feasible, efficient, or permitted by universally-accepted protocols for a single frame or segment. Thus, data to be transmitted and received will typically be divided into a plurality of frames (at the IP layer) and into a plurality of segments (at the TCP layer). TCP protocols provide for the sending and receipt of variable-length segments of information enclosed in datagrams. TCP protocols provide for the proper handling (transmission, receipt, acknowledgement, and retransmission) of segments associated with a given communication.

At its lowest level, computer communications of data packages or packets of data are assumed to be unreliable. For example, packets of data may be lost or destroyed due to transmission errors, hardware failure or power interruption, network congestion, and many other factors. Thus, the TCP protocols provide a system in which to handle the transmission and receipt of data packets in such an unreliable environment. For example, based on TCP protocol, a destination machine is adapted to receive and properly order segments, regardless of the order in which they are received, regardless of delays in receipt, and regardless of receipt of duplicate data. This is achieved by assigning sequence numbers (left edge and right edge) to each segment transmitted and received. The destination machine further acknowledges correctly received data with an acknowledgment (“ACK”) or a selective acknowledgment (“SACK”) back to the source machine. An ACK is a positive acknowledgment of data up through a particular sequence number. By protocol, an ACK of a particular sequence number means that all data up to but not including the sequence number ACKed has been received. In contrast, a SACK, which is an optional TCP protocol that not all systems are required to use, is a positive acknowledgement of data up through a particular sequence number, as well as a positive acknowledgment of up to 3-4 “regions” of non-continguous segments of data (as designated by their respective sequence number ranges). From a SACK, a source machine can determine which segments of data have been lost or not yet received by the destination machine. The destination machine also advertises its “local” offer window size (i.e., a “remote” offer window size from the perspective of the source machine), which is the amount of data (in bytes) that the destination machine is able to accept from the source machine (and that the source machine can send) prior to receipt of (i.e., without having to wait for) any ACKs or SACKs back from the destination machine. Correspondingly, based on TCP protocols, a source machine is adapted to transmit segments of data to a destination machine up to the offer window size advertised by the destination machine. Further, the source machine is adapted to retransmit any segment(s) of data that have not been ACKed or SACKed by the destination machine. Other features and aspects of TCP protocols will be understood by those skilled in the art and will be explained in greater detail only as necessary to understand and appreciate the present invention. Such protocols are described in greater detail in a number of publicly-available RFCs, including RFCs 793, 2988, 1323, and 2018, which are incorporated herein by reference in their entirety.

The act of formatting and processing TCP communications at the segment level is generally handled by computer hardware and software at each end of a particular communication. Typically, software accessed by the central processing unit (CPU) of the sender and the receiver, respectively, manages the bulk of TCP processing in accordance with industry-accepted TCP protocols. However, as the demand for the transfer of greater amounts of information at faster speeds has increased and as available bandwidth for transferring data has increased, CPUs have been forced to devote more processing time and power to the handling of TCP tasks—at the expense of other processes the CPU could be handling. “TCP Offload Engines” or TOEs, as they are often called, have been developed to relieve CPUs of handling TCP communications and tasks. TOEs are typically implemented as network adapter cards or as components on a network adapter card, which free up CPUs in the same system to handle other computing and processing tasks, which, in turn, speeds up the entire network. In other words, TCP tasks are “off-loaded” from the CPU to the TOE to improve the efficiency and speed of the network that employees such TOEs.

Conventional TOEs use a combination of hardware and software to handle TCP tasks. For example, TOE network adapter cards have software and memory installed thereon for processing TCP tasks. TOE application specific integrated circuits (ASICs) are also used for improved performance; however, ASICs typically handle TCP tasks using firmware/software installed on the chip and by relying upon and making use of readily-available external memory. Using such firmware and external memory necessarily limits the number of connections that can be handled simultaneously and imposes processing speed limitations due to transfer rates between separate components. Using state machines designed into the ASIC and relying upon the limited memory capability that can be integrated directed into an ASIC improves speed, but raises a number of additional TCP task management hurdles and complications if a large number of simultaneous connections are going to be managed efficiently and with superior speed characteristics.

For these and many other reasons, there is a need for systems and methods for improving TCP processing capabilities and speed, whether implemented in a TOE or a CPU environment.

There is a need for systems and methods of improving the speed of TCP communications, without sacrificing the reliability provided by TCP.

There is a need for systems and methods that take advantage of state machine efficiency for handling TCP tasks but in a way that remains compliant and compatible with conventional TCP systems and protocols.

There is a need for systems and methods that enable state machine implemented on one or more computer chips to handle TCP communications on the order of 1000 s and 10,000 s simultaneous communications and at processing speed exceeding 10 GHz.

There is a need for a system using a hardware TOE device that is adapted to support the Selective ACK (SACK) option of TCP protocol so that a source machine is able to cut back or minimize unnecessary retransmission. In other words, a system in which the source machine only retransmits the missing segments and avoids or minimizes heavy network traffic.

There is yet a further need for a system or device having a hardware-based SACK tracking mechanism that is able to track and sort data segments at high speeds—within a few clock cycles.

There is also a need for a system in which the destination machine provides network convergence by limiting the total amount of data segments that the source machine cn inject into the network when the destination machine is in “exception processing” mode where it needs to reorder incoming data segments before it hands off data to the application layer.

For these and many other reasons, there is a general need for a method of processing and reordering out-of-order TCP segments by a high-speed TCP receiving device having limited on-chip memory, wherein in-order TCP segments received from a TCP sending device are forwarded on to an appropriate application in communication with the TCP receiving device, comprising (i) storing a first out-of-order TCP segment in the limited on-chip memory of the high-speed TCP receiving device, the first out-of-order TCP segment defining a SACK region, (ii) determining the gap between a last-received in-order TCP segment and the SACK region, (iii) for each later-received out-of-order TCP segment that is contiguous with but non-cumulative with the SACK region, (a) storing said later-received out-of-order TCP segment in the limited on-chip memory of the high-speed TCP receiving device; and (b) expanding the SACK region to include said later-received out-of-order TCP segment, and (iv) when the gap between the last received in-order TCP segment and the SACK region is filled, forwarding each out-of-order TCP segment included within the SACK region on to the appropriate application.

There is also a need for TCP offload engine for use in processing TCP segments in a high-speed data communications network, the TCP offload engine having an architecture integrated into a single computer chip, comprising: (i) a TCP connection processor for receiving incoming TCP segments, the TCP connection processor adapted to forward in-order TCP segments to an appropriate application in communication with the TCP offload engine, each in-order TCP segment having a sequence number, (ii) a memory component for storing contiguous but non-cumulative out-of-order TCP segments forwarded by the TCP connection processor, the out-of-order TCP segments defining a SACK region, wherein the SACK region is defined between a left edge and a right edge sequence number, and (iii) a database in communication with the TCP connection processor, the database storing the sequence number of the last-received in-order TCP segment and storing the left edge and right edge sequence numbers of the SACK region, wherein the SACK region is fed back to the TCP connection processor when the left edge of the SACK region matches up with the sequence number of the last received in-order TCP segment.

The present invention meets one or more of the above-referenced needs as described herein in greater detail.

### SUMMARY OF THE PRESENT INVENTION

The present invention relates generally to computer communication systems and protocols, and, more particularly, to methods and systems for high speed TCP communications using improved TCP Offload Engine (TOE) techniques and configurations. Briefly described, aspects of the present invention include the following.

In a first aspect of the present invention, a method of processing and reordering out-of-order TCP segments by a high-speed TCP receiving device having limited on-chip memory, wherein in-order TCP segments received from a TCP sending device are forwarded on to an appropriate application in communication with the TCP receiving device, comprises (i) storing a first out-of-order TCP segment in the limited on-chip memory of the high-speed TCP receiving device, the first out-of-order TCP segment defining a SACK region, (ii) determining the gap between a last-received in-order TCP segment and the SACK region, (iii) for each later-received out-of-order TCP segment that is contiguous with but non-cumulative with the SACK region, (a) storing said later-received out-of-order TCP segment in the limited on-chip memory of the high-speed TCP receiving device; and (b) expanding the SACK region to include said later-received out-of-order TCP segment, and (iv) when the gap between the last received in-order TCP segment and the SACK region is filled, forwarding each out-of-order TCP segment included within the SACK region on to the appropriate application.

In further features of the first aspect, the method further comprises discarding any out-of-order TCP segment that is merely cumulative with the SACK region, discarding any out-of-order TCP segment that is noncontiguous with the SACK region, and discarding any zero-payload TCP segments.

In other features, the method further comprises periodically sending a selective acknowledgment (SACK) back to the TCP sending device for the SACK region and periodically sending an acknowledgment (ACK) back to the TCP sending device for the last-received in-order TCP segment.

Generally, the gap between the last received in-order TCP segment and the SACK region is closed by receipt of an additional in-order TCP segment.

In an other feature, the TCP segments of the SACK region are re-ordered using a connection link list chain.

Preferably, in additional various features, the SACK region is defined between a left edge and a right edge sequence number and the later-received out-of-order TCP segment causes an update to the right edge sequence number, or an update to the left edge sequence number, or an update to both the left edge and right edge sequence numbers.

Preferably, during processing of out-of-order TCP segments by the TCP receiving device, the size of a local offer window of the TCP receiving device advertised to the TCP sending device is closed by an amount equivalent to the size of in-order TCP segments received thereafter.

Also preferably, after the step of forwarding each out-of-order TCP segment included within the SACK region on to the appropriate application, the size of the local offer window of the TCP receiving device advertised to the TCP sending device is returned to its default value.

In yet a further feature, a new TCP segment received during the step of forwarding each out-of-order TCP segment included within the SACK region on to the appropriate application is treated as a new first out-of-order TCP segment of a new SACK region.

In a second aspect of the present invention, a TCP offload engine for use in processing TCP segments in a high-speed data communications network, the TCP offload engine having an architecture integrated into a single computer chip, comprises: (i) a TCP connection processor for receiving incoming TCP segments, the TCP connection processor adapted to forward in-order TCP segments to an appropriate application in communication with the TCP offload engine, each in-order TCP segment having a sequence number, (ii) a memory component for storing contiguous but non-cumulative out-of-order TCP segments forwarded by the TCP connection processor, the out-of-order TCP segments defining a SACK region, wherein the SACK region is defined between a left edge and a right edge sequence number, and (iii) a database in communication with the TCP connection processor, the database storing the sequence number of the last-received in-order TCP segment and storing the left edge and right edge sequence numbers of the SACK region, wherein the SACK region is fed back to the TCP connection processor when the left edge of the SACK region matches up with the sequence number of the last received in-order TCP segment.

Preferably, the TCP connection processor sends acknowledgements for in-order TCP segments and sends selective acknowledgements for the SACK region to a TCP sending device from which the TCP segments are sent.

In a feature of the second aspect, the TCP offload engine further comprises an input buffer for receiving incoming TCP segments and pacing the TCP segments provided to the TCP connection processor.

Preferably, the memory component comprises a memory manager, a memory database, and a connection link list table.

In another feature, the TCP offload engine interfaces with a TCP microengine for processing of out-of-order TCP segments.

The present invention also encompasses computer-readable medium having computer-executable instructions for performing methods of the present invention, and computer networks, state machines, and other hardware and software systems that implement the methods of the present invention.

The above features as well as additional features and aspects of the present invention are disclosed herein and will become apparent from the following description of preferred embodiments of the present invention.

### BRIEF DESCRIPTION OF THE DRAWINGS

Further features and benefits of the present invention will be apparent from a detailed description of preferred embodiments thereof taken in conjunction with the following drawings, wherein similar elements are referred to with similar reference numbers, and wherein:

FIG. 1 is a system view of a conventional TCP/IP communication system in which the present invention operates;

FIG. 2 illustrates conventional TCP/IP layers in which the present invention operates;

FIG. 3 illustrates a conventional TCP/IP system for packaging and unpackaging data in a TCP/IP system of the present invention;

FIG. 4 is a component view of a preferred, high speed, TCP-dedicated receiver of the present invention;

FIG. 5 is a graph showing the receipt and handling of a plurality of exemplary TCP segments by the receiver of FIG. 4;

FIG. 6 is a graph showing the receipt and handling of another plurality of exemplary TCP segments by the receiver of FIG. 4;

FIG. 7 is a combined chart/table illustrating how different types of segments are handled and processed by the receiver of FIG. 4;

FIG. 8 is an exemplary link list relationship table as utilized by the receiver of FIG. 4;

FIG. 9 is an another exemplary link list relationship table utilized by the receiver of FIG. 4;

FIG. 10 is a timeline illustrating the impact of segment processing events on flags utilized by the receiver of FIG. 4;

FIG. 11 is a graph showing the receipt and handling of another plurality of exemplary TCP segments by the receiver of FIG. 4; and

FIG. 12 is a table showing the impact of segment processing events on each of a plurality of variables and flags utilized by the receiver of FIG. 4.

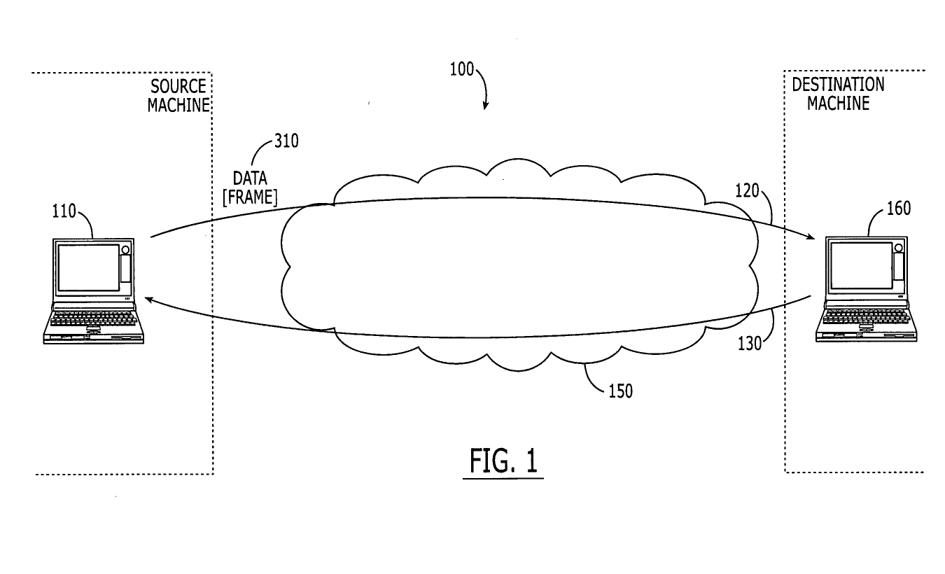

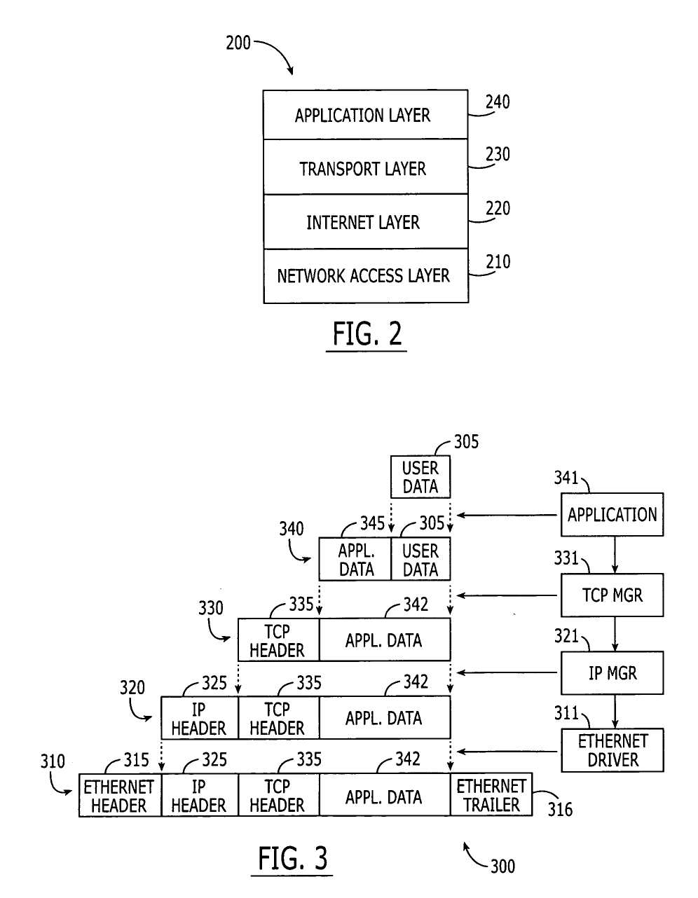

### DETAILED DESCRIPTION OF PREFERRED EMBODIMENTS

In conventional TCP software systems accessed by a CPU or in a conventional TOE device using firmware to perform out of order sorting, it is easy but relatively slow to manage the receipt of out-of-order segments and reorder the same prior to passing such data on to the relevant application. For example, it generally costs several hundred clock cycles to perform sorting of a segment in an out of order chain. In other words, a conventional system is only capable of running at a processing speed of approximately 1 gigabit (Gbit) per segment when out of order sorting is enabled.

In contrast, the system of the present invention performs sorting directly in the hardware and the hardware uses a messages to notify the microengine when it starts or ends a resorting process. The hardware system requests that the microengine send the entire sorted data chain back to the hardware for resorting without requiring firmware to perform such sorting. With this type of arrangement, the system of the present invention is capable of processing 10 Gbit per second or more.

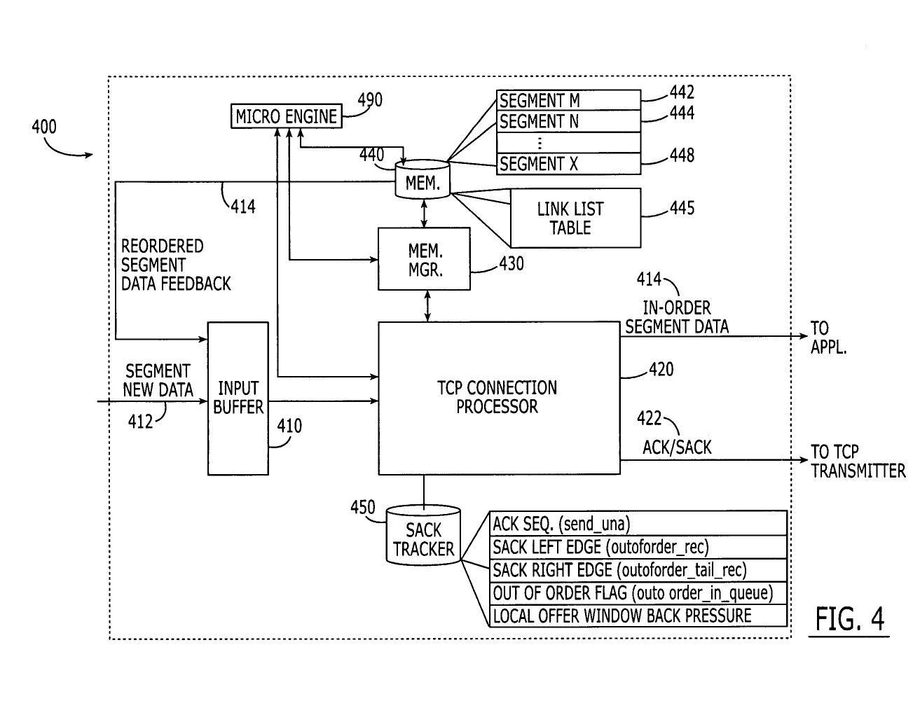

In a first aspect of the present invention, a TCP receiver 400 portion of a high-speed TOE device that is adapted to receive and manage TCP segments received by a destination machine is illustrated in simplified block format in FIG. 4. The receiver 400 of the high-speed TOE device of the destination machine includes an input buffer 410 and a TCP connection processor 420. The input buffer 410 merely receives and forwards TCP data segments upon request from the connection processor 420 or at predetermined clock intervals. Preferably, the connection processor 420 is implemented as a hard-coded state machine in hardware (preferably in a single microchip) rather than as a microprocessor or processor-software combined system. The receiver 400 of the high-speed TOE device also includes a segment data memory manager 430 connected to a segment database 440 that stores, when necessary, out-of-order segment data 442, 444, 448. The segment data memory manager 430 is also connected to and manages a link list table 445. As will be explained in greater detail herein, the link list table 445 tracks and properly orders the out-of-order segment data 442, 444, 448. The receiver 400 also includes a SACK tracking database 450 that maintains ACK sequence 451, SACK left edge 452, SACK right edge 454, out-of-order flag 456, and local offer window back pressure flag 458 variables in memory. The receiver 400 communicates with a microengine 490 whenever an out of order segment is received by the TCP connection processor 420. The microengine 490 is separate from the receiver 400, but is in communication with the connection processor 420, memory manager 430, and memory 440 of the receiver 400. Each of the above components will be discussed in greater detail hereinafter.

Preferably, the receiver 400 is configured to: (i) detect out-of-order segments; (ii) link reordered out-of-order segments in a connection-based link list chain; (iii) drop all zero-payload segments without chaining; (iv) capture and link reordered out-of-order non-zero-payload segments that belong to the “first” or “current” transmit SACK range only; (v) drop all zero-payload segments to minimize memory storage per connection; (vi) provide network convergence before connection is fully recovered from reorder out-of-order exception processing; and (vii) provide minimal memory usage for each TCP connection by:
using only 1 bit for SACK valid record;
using 32 bits for head sequence number (left edge) for first SACK range;
using 32 bits for tail sequence number (right edge) for first SACK range;
using 1 bit for local offer window back-pressured flag;
having a link list head pointer;
having a link list tail pointer;
providing a link list frame tag for linking processing unit; and
making the chain link list accessible by the system microprocessor so that the system microprocessor is able to release from buffer memory any segment chains that remain in the chain link list for an extended period of time or if the corresponding connection is no longer active.

Thus, with reference still to FIG. 4, new segment data 412 received by the destination machine is passed to the input buffer 410 and then on to the connection processor 420. The connection processor 420 determines whether the new segment data 412 is “in-order” or “out-of-order” for the relevant communication. In-order segment data 414 is passed on to the relevant application. The appropriate ACK information 422, as maintained in ACK sequence variable 451, is also passed on to a TCP transmitter (not shown in FIG. 4) for transmission of an appropriate ACK, in conventional manner, back to the source machine to indicate that the data segment has been received.

When the connection processor 420 receives a “first” out-of-order segment, the connection processor 420 first determines whether the out-of-order data segment has a sequence range that is within the current local offer window size. If so, then the out-of-order flag and local offer window back pressure flag variables 456,458 are both activated. The TCP connection processor 420 sends an “out of order” message to the microengine 490. The microengine 490 then causes the data segment to be sent to the segment data memory manager 430, which stores the segment in database 440 and starts a link list chain in link list table 445. This chain represents a “first” or “current” SACK region. This region may be expanded, but no new SACK regions will be stored in memory, as discussed hereinafter. The left edge and right edge (plus one) sequence numbers of the out-of-order segment are also stored in their respective variable locations 452, 454.

If the out-of-order data segment has a sequence range that is beyond the current local offer window size, it is merely dropped or discarded. As will also be apparent, the offer window advertised by the receiver 420 will continue to slide (i.e., stay the same size) in conventional manner as long as segments are received and processed in-order. Once an out-of-order segment is received, however, the offer window will begin to close to ensure that the receiver 420 does not receive more segments than it can handle with its limited memory and forward on to the relevant application in-order.

Further, if the data segment has a zero-payload, it is also dropped. Each of these measures ensures that the limited memory available to the receiver 420 is used in an efficient manner.

All in-order data segments received continue to be handled in the same manner as the first in-order data segment. Each in-order data segment is passed on to the application and the ACK sequence number is updated.

Any further out-of-order data segments are compared to the first or current SACK region. If any out-of-order segment is not contiguous with (i.e., there is no resulting gap between the sequence number of the new out-of-order segment and the sequence numbers of the current SACK region) and does not also expand either the left edge or right edge of the current chain, it is discarded. If the next out-of-order segment is contiguous with and expands the left edge of the current SACK region, the segment is stored in database 440, the SACK left edge variable 452 is updated, and the new segment is chained to the “head” of the current SACK region chain in the table 445. If the next out-of-order segment is contiguous with and expands the right edge of the current SACK region, the segment is stored in database 440, the SACK right edge variable 454 is updated, and the new segment is chained to the “tail” of the current SACK region chain in the table 445. This occurs unless adding such segment to the chain will cause the offer window size to be exceeded. Such a scenario should not occur unless the source machine sends data in excess of the offer window size, which is not permitted under TCP protocol. If the next out-of-order segment is contiguous with and expands both the right and the left edges of the current SACK region, the segment is stored in database 440, both the SACK left edge and right edge variables 452, 454 are updated, and the new segment is chained to the “head” of the current SACK region chain in the table 445.

When all segments prior to the current SACK region have been received by the receiver 420, the out-of-order flag 456 is deactivated, which triggers a SACK region feedback process. During the SACK region feedback process, an “end of sorting” message is sent from the TCP connection processor 420 to the microengine 490, which then commands the memory manager 430 to transfer all data back to the input buffer 410 for processing again. More specifically, segments from the SACK region are retrieved in-order from the database 440, based on their proper sequence arrangement dictated by the link list table 445, and are fed back to the receiver 420 along re-ordered segment data feedback path 414. Each now-in-order segment is then passed on to the application in conventional manner by the receiver 420 and the ACK sequence number is updated for each segment so processed. During the feedback process, the offer window back pressure flag 458 remains active to prevent segment volume from overwhelming the receiver 420 before it can get caught up with the feedback of the current SACK region, as will be explained in greater detail hereinafter. Once the feedback process is complete and assuming a new SACK region was not been created during the feedback process, the offer window back pressure flag is deactivated and the offer window size returns to its original value.

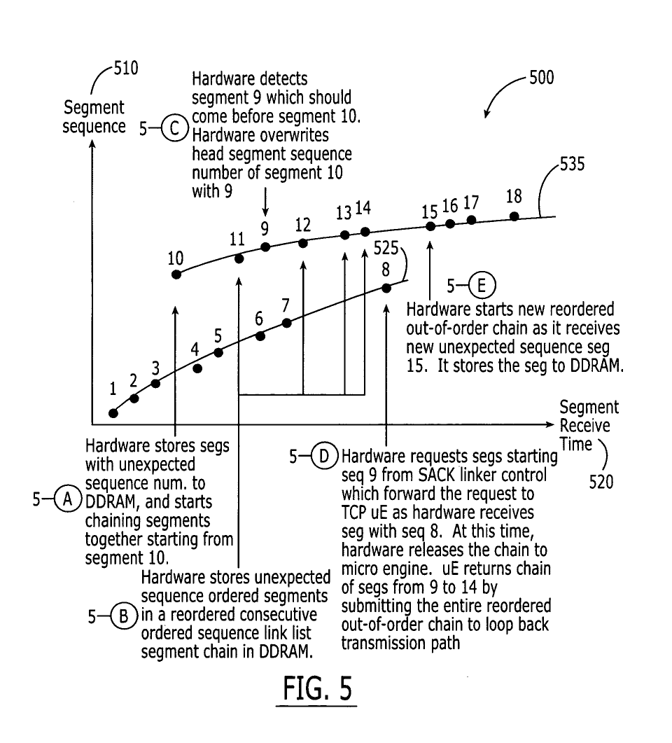

The above process will be more readily apparent with reference to several specific examples disclosed in a variety of ways through FIGS. 5 through 11. For example, turning first to FIG. 5, a graph 500 illustrates TCP data segments 1-18 (shown as numbered points 1-18 on the graph) as received over a period of time. The y-axis of the graph 500 represents the segment sequence number 510. The x-axis of the graph 500 represents time or, more specifically, the relative segment receive time 520. Specific time units for this axis are not relevant. Two lines 525, 535 are plotted through segments 1-18. In-order line 525 represents those segments received and processed in-order. Out-of-order line 535 represents those segments that are received and processed as out-of-order segments.

We will now explain what happens as each segment is received by the TCP receiver of the present invention. In this example, segments 1-3 are received in-order and are processed in conventional manner. At time 5-A, segment 10 is received out-of-order. Segment 10 data is stored in DDRAM, and a SACK region starting with segment 10 is started. Segments 4 and 5 are then received and since they are the expected segments to follow segment 3, they are in-order and are processed normally. At time 5-B, segment 11 is received out-of-order. Segment 11 data is also stored in DDRAM, and the SACK region is updated to include segment 11 after segment 10 (i.e., the link list table is updated and segment 11 is attached to the tail of the existing chain). Segment 6 is then received in-order and processed normally. At time 5-C, segment 9 is received out-of-order. Even though segment 9 precedes the current chain comprised of segments 10 and 11, segment 9 is continguous with the existing chain; thus, segment 9 data is also stored in DDRAM, and the SACK region is updated to include segment 9 ahead of segment 10 (i.e., the link list table is updated and segment 9 is attached to the head of the existing chain). Segment 7 is then received in-order and processed normally. Segments 12-14 are then received out-of-order when compared with the last in-order segment 7, and are treated like segment 11. Segments 12-14 are stored in DDRAM, and the SACK region is updated to include segments 12, 13, and 14 after segment 11 (i.e., the link list table is sequentially updated and segments 12-14 are sequentially attached to the tail of the existing SACK region chain). At time 5-D, segment 8 is received in-order. It is processed normally. The receiver then recognizes that the SACK region currently stored in DDRAM follows the last in-order segment (i.e., segment 8) received. The receiver initiates the feedback process and requests feedback of the segments, in-order, from DDRAM starting with segment 9. Before segments 9-14 have been completely processed by the receiver and forwarded to the relevant application, segments 15-18 are received at time 5-E. Segments 15-18 are considered to be out-of-order since segment 14 has not yet been fully processed as of time 5-E. Segments 15-18 are stored in DDRAM and treated as the new or current SACK region that is stored as a link list chain, since the previous SACK region chain of segments 9-14 was already “released” by the system when the feedback process was initiated.

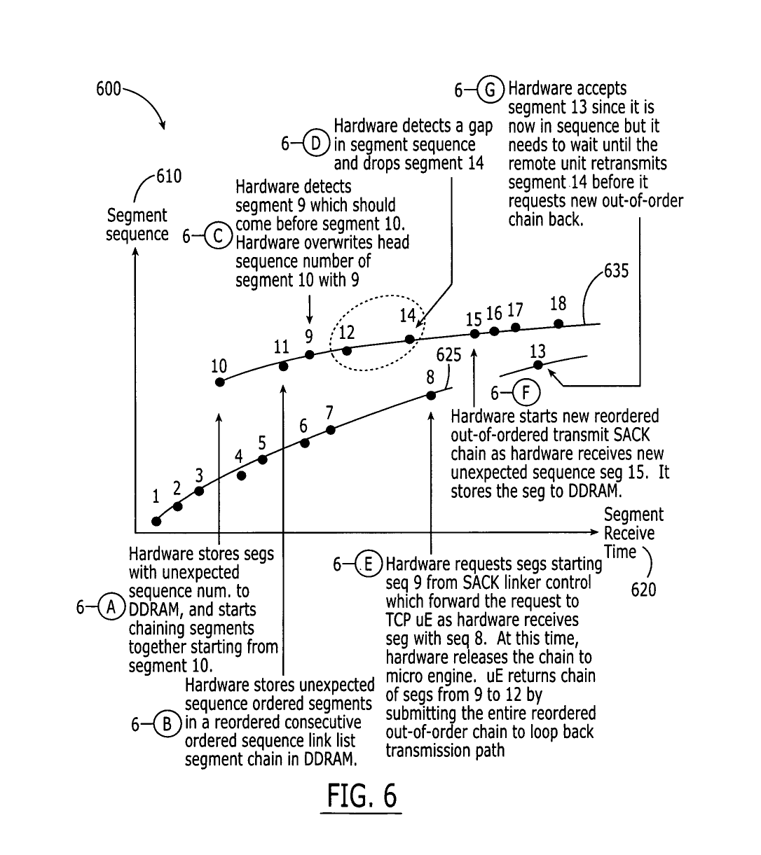

As with FIG. 5, FIG. 6 illustrates a graph 600 that plots TCP data segments 1-18 (again shown as numbered points 1-18 on the graph) as received over a period of time. The y-axis of the graph 600 represents the segment sequence number 610 and the x-axis of the graph 600 represents the relative segment receive time 620. In-order line 625 represents those segments received and processed in-order. Out-of-order line 635 represents those segments that are received and processed as out-of-order segments.

In contrast with FIG. 5, segment 13 of FIG. 6 is received much later in time. The impact of this is as follows. First, segments 1-7 and segments 9-12 are handled and processed in the same manner as was described in association with FIG. 5. At time 6-D, however, segment 14 is received out-of-order. Because segment 14 is not continguous with the current SACK region, which is made up of segments 9-12, segment 14 is dropped or discarded by the system. At time 6-E, segment 8 is received in-order and is processed normally. The receiver then recognizes that the SACK region currently stored in DDRAM (i.e., segments 9-12 only) follows the last in-order segment (i.e., segment 8) received. The receiver initiates the feedback process and requests feedback of the segments, in-order, from DDRAM starting with segment 9. Before segments 9-12 have been completely processed by the receiver and forwarded to the relevant application, segments 15-17 are received at time 6-F. Segments 15-17 are considered to be out-of-order since segment 12 has not yet been fully processed as of time 6-F. Segments 15-17 are stored in DDRAM and treated as the new or current SACK region that is stored as a link list chain, since the previous SACK region chain of segments 9-12 was already “released” by the system when the feedback process was initiated. At time 6-G, segment 13 is received. Since the feedback process has already completed the processing of segments 9-12, segment 13 is handled as an in-order segment and processed normally. Segment 18 is then received at a later time and it is appended to SACK region made up of segments 15-17. This SACK region will not be released to the feedback process until segment 14 is retransmitted by the source machine and processed as an in-order segment at a later time (not shown).

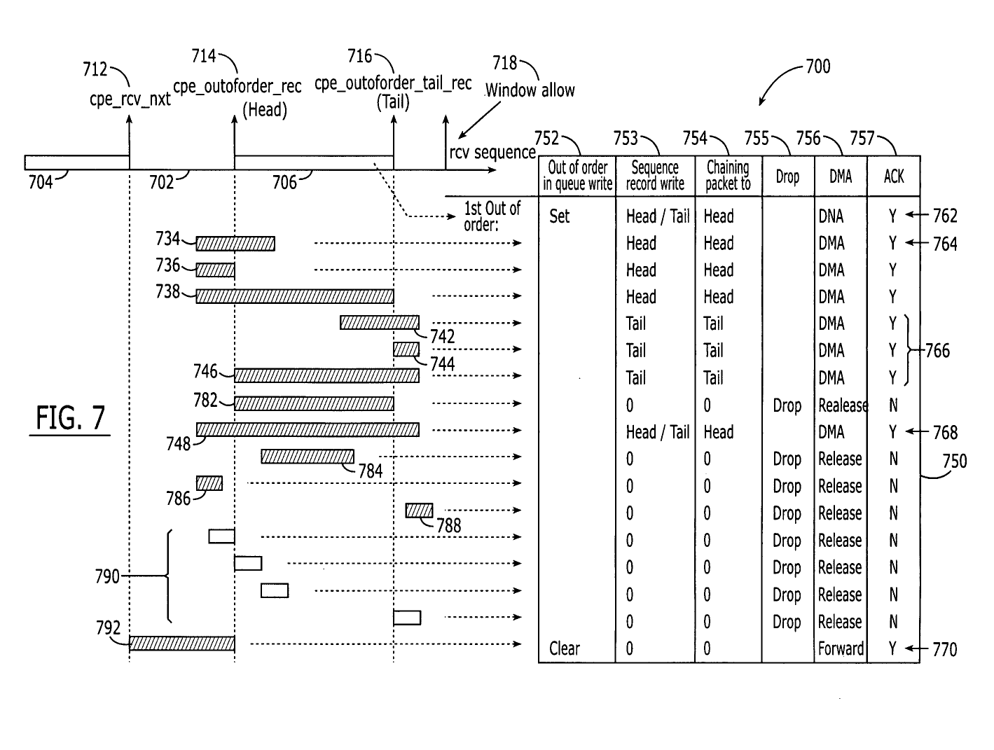

FIG. 7 is a complex chart/table 700 combination illustrating, in another manner, how different out-of-order segments are process or handled by the present invention. At the top left of the chart/table 700 is a timeline 702 showing segments received and the relative sequence range of such segments. For example, all in-order segments previously received for this particular TCP connection is designed by block 704. The rcv_nxt variable 712 indicates the ACK sequence number of the last in-order segment received—this corresponds with the ACK sequence variable 451 from FIG. 4. The first out-of-order segment that initially defines the first or current SACK region is designated by block 706. The SACK region has a left edge or head designated by the out_of order_rcv variable 714 and a right edge or tail designated by the out_of_order_tail_rcv variable 716—these variables correspond with the same respective variables 452,454 of FIG. 4. The space between variables 712 and 714 illustrates the “missing” segment(s) or range of data that needs to be received to bring the SACK region back into order. The window allow arrow 718 indicates the maximum sequence number that the TCP receiver can receive and remain within the advertised offer window size.

On the right side of the chart/table 700 of FIG. 7 is a table 750. The table 750 has several columns of information. The first column 752 indicates the state of the out_of_order_in_queue variable, which corresponds with the out-of-order flag 456 from FIG. 4. It is set to 1 or activated by a “set” command. It is set to 0 or deactivated by a “clear” command. The second column 753 called “sequence record/write” indicates whether the currently-received segment causes the right edge or the left edge sequence number variables of the current SACK region to be updated. A “head/tail” command causes both the left edge and right edge sequence numbers of the current SACK region to be updated. A “head” command updates the left edge sequence number. A “tail” command updates the right edge sequence number. A “0” indicates that there is no change made to the SACK region sequence numbers. The third column 754 called “chaining packet to” indicates whether the currently-received segment should be linked to the head or tail of the current chain stored in the link list. A “0” in this column 754 means that the currently-received segment is not linked to the current chain in the link list. The fourth column 755 called “drop” indicates whether the currently received segment should be dropped or discarded without being stored in memory or DDRAM. The fifth column 756 called “DMA” is related to the fourth column but indicates affirmatively whether the currently-received segment should be stored in memory or DDRAM (indicated by “DMA” command), released (i.e., dropped or discarded from the temporary local buffer that is used to hold the segment briefly before it is processed by the receive processor), or forwarded. The “forward” command indicates that the current SACK region 706 should be sent to the receive processor as part of the feedback process, as described previously. The last column 757 called “ACK” indicates whether the ACK sequence number or the SACK right edge or left edge has been updated, which would need to be communicated back to the source machine through an ACK or a SACK by the TCP transmitter, as described earlier. The impact of the receipt of SACK region 706 is shown in the table 750 at line 762.

At the lower left side of the chart/table 700 are a plurality of potential segments that could be received. The impact of each such segment is shown by its effect on the data in each column of table 750 in the corresponding row. It is assumed that in-order segments 704 and out-of-order SACK region 706 has already been received by the system and that only that particular segment is received by the system. For example, if segment 734 (which includes non-cumulative data at the left edge of the SACK region and some cumulative data) were to be received by the system, it would be processed as shown in row 764 of table 750. As shown, if segments 734, 736, or 738 were to be received by the system, they would be handled in the same manner—the left edge sequence number would be updated, the segment data would be stored in memory, and it would be appended to the head of the current SACK region in the link list. If segment 742, 744, or 746 were to be received by the system (again, assuming only blocks 704 and 706 had been previously received), they would be handled as shown in rows 766 of table 750—the right edge sequence number would be updated, the segment data would be stored in memory, and it would be appended to the tail of the current SACK region in the link list. If segment 782 were to be received (again, assuming only blocks 704 and 706 had been previously received), it would merely be dropped or discarded since it was cumulative with the current SACK region 706. Segment 784 would be handled in the same manner as segment 782 since it provides no additional information (and even less information than segment 782) that is not already contained in SACK region 706. If segment 748 were to be received (again, assuming only blocks 704 and 706 had been previously received), as shown in row 768 of table 750, both the right edge and left edge sequence numbers would be updated, the segment data would be stored in memory, and it would be appended to the head of the current SACK region in the link list even though it contain some data that is cumulative with the current SACK region 706. If segment 786 or 788 were to be received (again, assuming only blocks 704 and 706 had been previously received), they would simply be dropped because they are not continguous with the current SACK region 706. Segments 790 illustrate zero-payload segments received out-of order. Such segments are merely dropped or discarded to avoid tying up processing time of the TCP receiver and limited memory space. Finally, once segment (or group of segments) 792 is received (again, assuming only blocks 704 and 706 had been previously received), such segment is processed as an in-order segment and the feedback process is started to retrieve SACK region 706 from memory. As shown in row 770 of table 750, the out-of-order flag is deactivated and the segments of the current SACK region 706 are forwarded in-order to the receive processor to be handled as in-order segments.

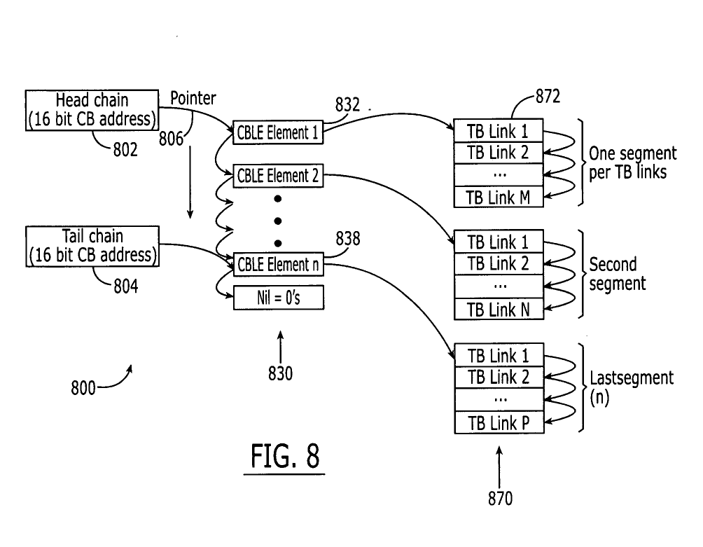

Turning now to FIG. 8, link list diagram 800 illustrates the manner in which the out-of-order segments for the single SACK region per TCP connection are stored and linked in the link list table 445 from FIG. 4. In particular, the reordered out-of-order segment chain is linked together thru Configuration Buffer Link Elements (CBLE) 830 and Transmit Buffer Link Elements (TBLEs) 870. The receive processor keeps track of left edge or head sequence number at address 802 and keeps track of right edge or tail sequence number at address 804. The receive processor then chains together out-of-order segments using CBLE 830, as shown. A pointer 806 points to the first segment 832 of the chain and a pointer 808 points to the last segment 838 of the chain. The CBLE 830 also maintains an internal pointing system between each continguous CBLE. Under current TCP protocol, a segment can range in size up to a 9K jumbo frame. A segment of this size will be stored in several transmit buffers (TBs) (not shown in FIG. 8), which are linked together by TB link elements (TBLEs) 870. For example, segment 1, which is represented by CBLE 832 is stored in multiple TBs, which are linked by TBLE 872. Each portion of TBLE 872 points to its respective TB (not shown), contains a byte count of the current TB, and contains the next link address of the next portion of the TBLE 872 in conventional manner.

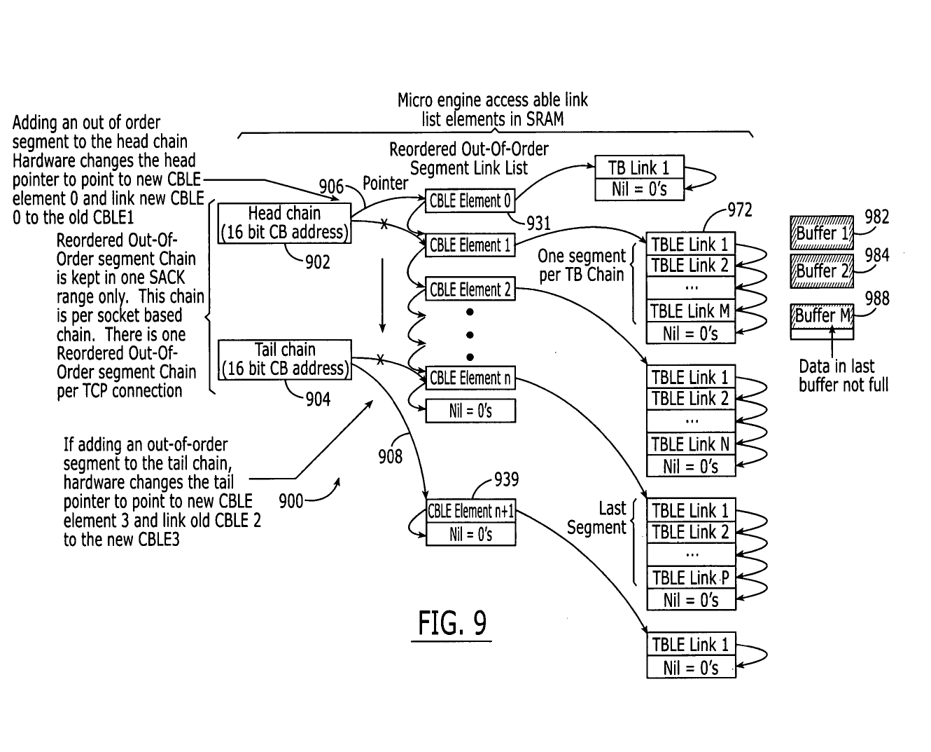

FIG. 9 is similar to FIG. 8 but illustrates how new out-of-order segments are appended to the head and tail of the current SACK region chain. For example, when a new out-of-order segment is added to the head of the chain, a new CBLE 931 is created, left edge or head sequence number at address 902 is updated, and pointer 906 is redirected to the new CBLE 931. CBLE 931 points to CBLE 932 in conventional manner. Correspondingly, when a new out-of-order segment is added to the tail of the chain, a new CBLE 939 is created, right edge or tail sequence number at address 904 is updated, and pointer 908 is redirected to the new CBLE 939. FIG. 9 also illustrates one set of several transmit buffers (TBs) 982, 984, 988, as pointed to by TBLE 972. In particular, TBs 982 and 984 are filled. TB 988 is not completely filled. CBLE 931 points to CBLE 932 in conventional manner.

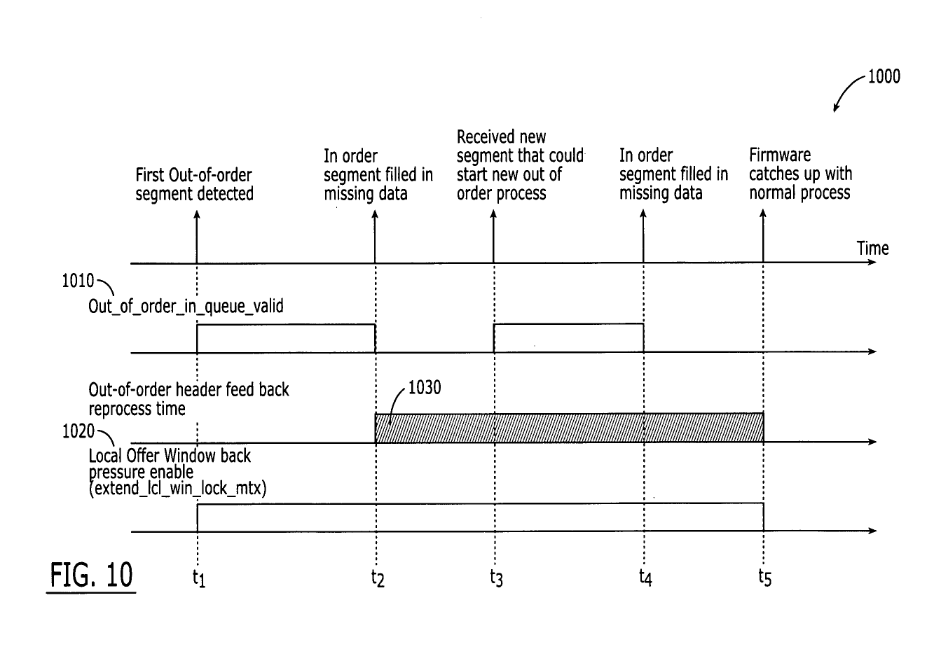

Turning now to FIG. 10, a timeline 1000 illustrates when the out-of-order flag 1010 (corresponding to out-of-order flag 456 from FIG. 4) and the local offer window back pressure flag 1020 (corresponding to back pressure flag 458 of FIG. 4), respectively, are activated or deactivated in response to different events or occurrences in the processing of out-of-order segments. Prior to t1, no out-of-order segments have been received for this particular TCP connection; thus, out-of-order flag 1010 and local offer window back pressure flag 1020 are both low or still in a deactivated state. At time t1, a first out-of-order segment is received and detected and both flags 1010, 1020 go high or are activated. The back pressure flag 1020 is used to “close” the local offer window to prevent the receiver from being overrun with data. All in-order segments received from this point on will be deducted from the local offer transmission window that the system advertises to the source machine on this particular TCP connection. At time t2, all missing data (i.e., data segments between the last in-order segment and the current SACK region have been received. This causes the out-of-order flag 1010 to deactivate; however, because the segments from the SACK region have not yet been fully processed during the feedback process, the local offer window back pressure flag 1020 remains activated. Again, this is to keep the receiver from being overrun with data while it is getting “caught up” on processing of the previous out-of-order segments. During the feedback process, the receiver sends a copy of the out-of-order chain head and tail pointers and segment data to a TCP assist micro engine. The micro engine then sends each of the segments of the SACK region in-order to the receiver along the feedback path, as previously described. The receiver then reprocess those segments as newly received segments.

Time block 1030 shows that the feedback process is still underway, which causes the local offer window flag 1020 to remain activated. At time t3, while the previous SACK region is still being processed through feedback, a new out-of-order segment is received. Even though this segment may be in-order right after the previous SACK region, it is treated as out-of-order because the feedback process has not yet completed. This starts a new, current SACK region and cause the out-of-order flag 1010 to reactivate. At time t4, all previous segments from the original out-of-order chain are finished the feedback process. The current SACK region then begins its own feedback process. The out-of-order flag 1010 deactivates but the back pressure window flag 1020 remain activated because of the on-going feedback process, as indicated by block 1030. Finally, at time t5, the feedback process is complete, as shown by block 1030. The back pressure window flag 1020 is deactivated and the local offer window returns to its normal advertised size.

It should be apparent to those skilled in the art that this process will converge as the local offer window is closed and the remote side does not have any new window available to transmit new data segments. Normally, the loop back path or feedback process is significantly faster then the receipt and processing of new data received from the source machine at a physical input port. Use of the back pressure flag 1020 to cause the offer window to close, however, ensures that the system will converge and that the receiver will not be overloaded with incoming segments before it can process out-of-order segments in the single SACK region that is being stored by the system.

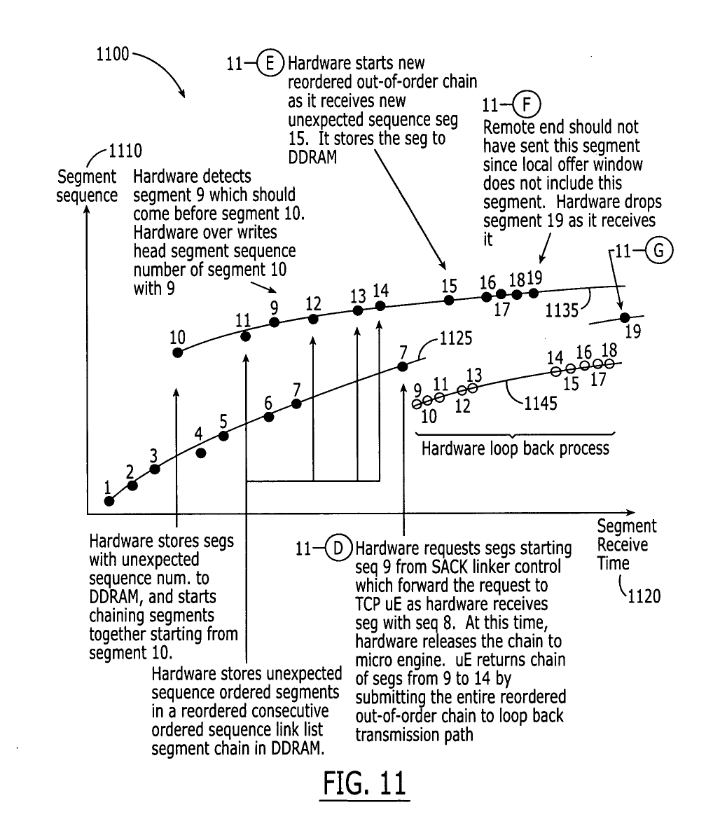

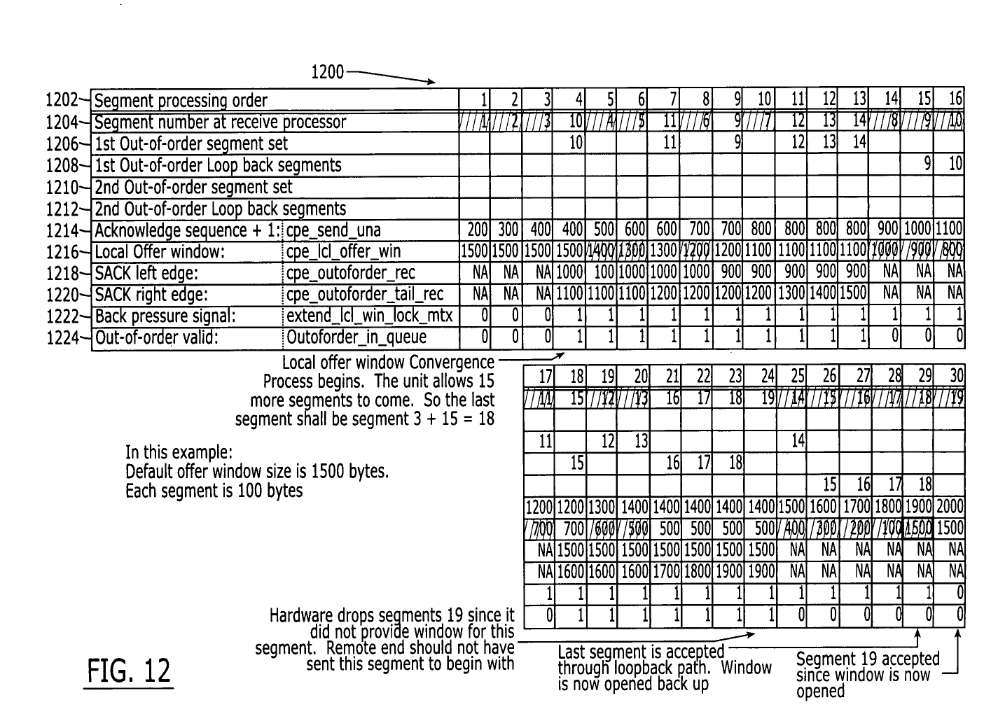

The above process is further illustrated by the example shown in FIGS. 11 and 12 that now follow. For purposes of the illustration, it will be assumed in FIGS. 11 and 12 that each segment has a length of 100 bytes and that the default window size is only 1500 bytes.

The graph 1100 of FIG. 11 is similar to the graph 500 of FIG. 5, however, an additional feedback line 1145 is shown relative to in-order line 1125 and out-of-order line 1135. TCP data segments 1-19 are shown as numbered points 1-19 on the graph 1100. The y-axis of the graph 1100 represents the segment sequence number 1110 and the x-axis of the graph 1100 represents the relative segment receive (or feedback) time 1120.

In-order segments 1-8 are handled in the same manner as was described in association with FIG. 5. Out-of-order segments 9-14 are also initially handled in the same manner as described in FIG. 5. At time 11-D, when segment 8 is received and processed in-order, the receiver recognizes that the SACK region currently stored in DDRAM follows the last in-order segment (i.e., segment 8) received. The receiver initiates the feedback process and requests feedback of the segments, in-order, from DDRAM starting with segment 9. The timing of the feedback and processing of segments 9-14 is shown on feedback line 1145. At time 11-E, before segment 12-14 have been processed by the receiver and forwarded to the relevant application, segment 15 is received. Segments 16-19 are also received prior to the feedback processing of segment 14. Thus, segments 15-19 are considered to be out-of-order since segment 14 has not yet been fully processed at the time of their receipt. Segments 15-19 are shown on out-of-order line 1135. As shown at time 1′-F and as will be explained in greater detail in FIG. 12, segment 19 should not have been sent by the source machine since it exceeds the offer window currently advertised by the destination machine. Thus, segment 19 is dropped by the system. After segment 14 is processed, segments 15 through 19 are processed along the feedback path, again, as shown on feedback line 1145. At time 11-G, segment 19 is received again from the source machine. It is received in-order and shown back on in-order line 1125.

Turning now to FIG. 12, table 1200 illustrates the values of the variables and flags previously described at each segment processing event shown in FIG. 11. Row 1202 shows each segment processing event 1-30. Row 1204 illustrates the segment number of the particular segment at the receive processor at each processing event. Row 1206 shows which segments are included in the first SACK region and the order in which they are received. Row 1208 illustrates the feedback loop of the first SACK region. Row 1210 shows which segments are included in the second SACK region and the order in which they are received. Row 1212 illustrates the feedback loop of the second SACK region. Row 1214 illustrates the ACK sequence number, which is the right edge sequence number (plus 1) of the last received in-order segment. Row 1216 shows the local window offer size offered at each segment processing event—assuming that the original offer window size is 1500 bytes and that each segment size is 100 bytes. Rows 1218 and 1220 illustrate the current SACK region left edge and right edge sequence numbers, respectively. Row 1222 illustrates the value of the back pressure flag and whether it is activated (high or set to 1) or deactivated (low or set to 0). Finally, row 1224 illustrates the value of the out-of-order flag and whether it is activated (high or set to 1) or deactivated (low or set to 0). Again, as was explained in association with FIGS. 10 and 11, segments 1-3 are received in-order and are processed in conventional manner; thus, the ACK sequence value goes up with receipt and processing of each segment, the window size remains at 1500 bytes, and the SACK values are nil since there is no current SACK region. At processing event 4, segment 10 is received out-of-order; thus, a first SACK region is created and chained, the ACK sequence number does not change, the window size does not yet change, a SACK region having a range 1000-1100 is created, and both flags are activated. The convergence process initiated by the activation of back pressure flag now starts. The source machine know, based on the ACK from event 3, that it can send up to 1500 bytes of segments to the destination machine without waiting for another ACK or SACK from the destination machine. That means that it can send only up through segment 18 based on the ACK from event 3. Next, segments 5 and 6 are received, which increments the ACK sequence number and decrements the window offer size. At processing event 7, segment 11 is received and added to the current SACK region, there is no change to the ACK sequence number or the window size, but the right edge of the SACK range increases. The receipt of in-order segment 6 increments the ACK sequence number and reduces the offer window size. Segment 9 is then received, which merely causes the left edge of the SACK region to update. At processing event 10, segment 7 is received in-order, which increases the ACK sequence number and decreases the offer window size. Next, segments 12-14 are received out-of-order, which increments the right edge of the SACK region. At event 14, segment 8 is received in-order. This causes the out-of-order flag to deactivate, since the current SACK region immediately follows segment 8. This initiates the feedback process for segments 9-14, releases the SACK region left edge and right values. As segments 9, 10 and 11 are processes in the feedback process, each segment processes increases the ACK sequence number and decreases the window offer size. At event 18, segment 15 is received out-of-order and starts a new SACK region. The out-of-order flag again is activated and the SACK region right and left edges are determined. There is no change to the Ack sequence or window offer size. Next, segments 12 and 13 are processed on the continuing feedback process for the original SACK region. This continues to increment the ACK sequence number and decrement the window offer size. At events 21-23, out-of-order segments 16-18 are received. As each segment is received, it increases the current (second) SACK region right edge value. At event 24, segment 19 is improperly received. The source machine should not have sent segment 19 because it exceeds the window size that the destination machine has been offering since processing event 4. Thus, segment 19 is dropped and none of the variables or flags are modified. At event 25, segment 14 from the original SACK region is finally processed as part of the first out-of-order feedback loop. This updates the Ack sequence to a value of 1500, continues to decrease the offer window size, resets or deactivates the out-of-order flag and resets the SACK region edge values. At events 26-29, segments 15-18 are processed as part of the second out-of-order feedback loop. The ACK sequence is updated with each process and the offer window size is decremented to zero at the initial processing of segment 18. Upon completion of the processing of segment 18, the back pressure flag is reset or deactivated, which allows the offer window size to reset back to 1500. At event 30, segment 19 can now be received because the window offer size is now back to 1500. Thus, the source machine can now send segments equivalent to 1500 bytes without waiting for an ACK or SACK back from the destination machine.

In view of the foregoing detailed description of preferred embodiments of the present invention, it readily will be understood by those persons skilled in the art that the present invention is susceptible to broad utility and application. While various aspects have been described in the context of a preferred embodiment, additional aspects, features, and methodologies of the present invention will be readily discernable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

1. A method of processing and reordering out-of-order TCP segments by a high-speed TCP receiving device having limited on-chip memory, wherein in-order TCP segments received from a TCP sending device are forwarded on to an appropriate application in communication with the TCP receiving device, comprising:
storing a first out-of-order TCP segment in the limited on-chip memory of the high-speed TCP receiving device, the first out-of-order TCP segment defining a SACK region;
determining the gap between a last-received in-order TCP segment and the SACK region;
for each later-received out-of-order TCP segment that is contiguous with but non-cumulative with the SACK region, (i) storing said later-received out-of-order TCP segment in the limited on-chip memory of the high-speed TCP receiving device; and (ii) expanding the SACK region to include said later-received out-of-order TCP segment;
when the gap between the last received in-order TCP segment and the SACK region is filled, forwarding each out-of-order TCP segment included within the SACK region on to the appropriate application.

2. The method of claim 1 further comprising discarding any out-of-order TCP segment that is merely cumulative with the SACK region.

3. The method of claim 1 further comprising discarding any out-of-order TCP segment that is noncontiguous with the SACK region.

4. The method of claim 1 further comprising discarding any zero-payload TCP segments.

5. The method of claim 1 further comprising periodically sending a selective acknowledgment (SACK) back to the TCP sending device for the SACK region.

6. The method of claim 1 further comprising periodically sending an acknowledgment (ACK) back to the TCP sending device for the last-received in-order TCP segment.

7. The method of claim 1 wherein the gap between the last received in-order TCP segment and the SACK region is closed by receipt of an additional in-order TCP segment.

8. The method of claim 1 wherein the TCP segments of the SACK region are re-ordered using a connection link list chain.

9. The method of claim 1 wherein the SACK region is defined between a left edge and a right edge sequence number.

10. The method of claim 9 wherein the later-received out-of-order TCP segment causes an update to the right edge sequence number.

11. The method of claim 9 wherein the later-received out-of-order TCP segment causes an update to the left edge sequence number.

12. The method of claim 9 wherein the later-received out-of-order TCP segment causes an update to both the left edge and right edge sequence numbers.

13. The method of claim 1 wherein, during processing of out-of-order TCP segments by the TCP receiving device, the size of a local offer window of the TCP receiving device advertised to the TCP sending device is closed by an amount equivalent to the size of in-order TCP segments received thereafter.

14. The method of claim 13 wherein, after the step of forwarding each out-of-order TCP segment included within the SACK region on to the appropriate application, the size of the local offer window of the TCP receiving device advertised to the TCP sending device is returned to its default value.

15. The method of claim 1 wherein a new TCP segment received during the step of forwarding each out-of-order TCP segment included within the SACK region on to the appropriate application is treated as a new first out-of-order TCP segment of a new SACK region.

16. A TCP offload engine for use in processing TCP segments in a high-speed data communications network, the TCP offload engine having an architecture integrated into a single computer chip, comprising:
a TCP connection processor for receiving incoming TCP segments, the TCP connection processor adapted to forward in-order TCP segments to an appropriate application in communication with the TCP offload engine, each in-order TCP segment having a sequence number;
a memory component for storing contiguous but non-cumulative out-of-order TCP segments forwarded by the TCP connection processor, the out-of-order TCP segments defining a SACK region, wherein the SACK region is defined between a left edge and a right edge sequence number;
a database in communication with the TCP connection processor, the database storing the sequence number of the last-received in-order TCP segment and storing the left edge and right edge sequence numbers of the SACK region; and
wherein the SACK region is fed back to the TCP connection processor when the left edge of the SACK region matches up with the sequence number of the last received in-order TCP segment.

17. The method of claim 16 wherein the TCP connection processor sends acknowledgements for in-order TCP segments and sends selective acknowledgements for the SACK region to a TCP sending device from which the TCP segments are sent.

18. The method of claim 16 further comprising an input buffer for receiving incoming TCP segments and pacing the TCP segments provided to the TCP connection processor.

19. The method of claim 16 wherein the memory component comprises a memory manager, a memory database, and a connection link list table.

20. The method of claim 16 wherein the TCP offload engine interfaces with a TCP microengine for processing of out-of-order TCP segments.
